(19) United States
(12) Patent Application Publication
(10) Pub. No.: US 2026/0094191 A1
(43) Pub. Date: Apr. 2, 2026

(54) MACHINE LEARNING MODEL FOR ASSOCIATING ITEMS

(71) Applicant: NCR Voyix Corporation, Atlanta, GA (US)

(72) Inventors: Tamar Miriam Haizler, Kfar-Saba (IL); Shiran Abadi, Tel-Aviv (IL)

(21) Appl. No.: 18/902,682

(22) Filed: Sep. 30, 2024

(51) Int. Cl. G06Q 30/0601

(52) U.S. Cl. CPC G06Q 30/0625; G06Q 30/0633

(57) ABSTRACT

System and techniques may be used for determining anomalous item pairs using machine learning. An example technique may include obtaining a list of items for sale, constructing a dataset of pairs of items including each possible item pair of items in the list of items for sale, and extracting a plurality of sets of pairwise measures for each pair of the pairs of items in the dataset, the plurality of sets of pairwise measures including a plurality of pairwise measures for each pair of the pairs of items in the dataset. The example technique may include determining a set of anomalous item pairs of the pairs of items using an anomaly detection model based on the plurality of sets of pairwise measures, and outputting the set of anomalous item pairs as associated items.

### BACKGROUND

Learning associations between retail items has long been studied to help retail chains in various aspects. However, most existing algorithms that aims to find associations, such as substitutes or complementary, rely on frequency dependent measures (such as Lift) or basket similarity, and do not take into account other characteristics such as item brand, size, price level, and more. Typically, associations are done manually by feeling.

### SUMMARY

In various embodiments, methods and systems for determining anomalous item pairs for sales.

According to an embodiment, a technique may include obtaining a list of items for sale, constructing a dataset of pairs of items including each possible item pair of items in the list of items for sale, and extracting a plurality of sets of pairwise measures for each pair of the pairs of items in the dataset, the plurality of sets of pairwise measures including a plurality of pairwise measures for each pair of the pairs of items in the dataset. The technique may include determining a set of anomalous item pairs of the pairs of items using an anomaly detection model based on the plurality of sets of pairwise measures, and outputting the set of anomalous item pairs.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a system for determining anomalous item pairs using machine learning in accordance with some examples.

FIG. 2 illustrates generally a table showing item pairs and pairwise measures in accordance with some examples.

FIG. 3 illustrates generally a block diagram showing association type determination in accordance with some examples.

FIG. 4 illustrates a machine learning engine for training and execution related to determining anomalous item pairs, according to various examples.

FIG. 5 illustrates generally a flowchart showing a technique for determining anomalous item pairs using machine learning in accordance with some examples.

FIG. 6 illustrates generally an example of a block diagram of a machine upon which any one or more of the techniques discussed herein may perform in accordance with some embodiments.

### DETAILED DESCRIPTION

The systems and techniques described herein may be used for determining anomalous item pairs using machine learning. The anomalous pairs may correspond to two items that are substitutes for each other (e.g., if one is unavailable, the other is likely to be purchased instead) or complementary (e.g., the two items are likely to be purchased together). The item pairs may be anomalous because they are rare (e.g., it is unlikely that an arbitrarily selected pair includes substitutes or complementary items). The item pairs may be analyzed using unsupervised machine learning for outlier detection, for example based on one or more of a variety of data measures about the items extracted from transactional data or an item catalog.

There are a variety of challenges that can be mitigated and supported by item association identification in retail chains. For example, for customer purchasing behavior, by analyzing which items are frequently bought together (complementary), retailers may optimize product placement or store layout. For inventory management, by identifying which products are commonly associated, retailers may better predict demand or minimize the risk of overstocking or understocking. For marketing, understanding item associations aids in designing effective promotional strategies or cross-selling opportunities.

Typically, associated items are defined by a set of rules, (e.g., by brand and product line, by type of item from different manufacturers, by name similarity, or the like). For example, name similarity may include a rule by which all the items with the string “peach” in the item name are defined as substitutes. However, in real data “peach” may also represent “peach color blush,” which is unlikely to be associated with the fruit. This approach is often incorrect.

Popular algorithmic approaches are based on computing similarity and lift from transactional data. Lift is a measurement term for how likely item A is to be bought with item B. Lift can be quite problematic to compute over retail baskets, as it is very common to see mixed baskets (e.g. basket for entire families) which makes it noisier and real associations harder to find. For example, a 1.5 liter bottles of one brand of soda and a 1.5 liter bottle of a second brand of soda, which should replace each other in a classic basket, actually are purchased together quite often.

A similarity metric, which may be computed by cosine similarity, is derived from natural language models and is used to compute similarity of “contexts.” In such models, given two words, the similarity is computed between the words that surround each of them in the containing two sentences. By analogy, a sentence is represented by a basket and a word by the item, and so, given two items, the similarity measures the similarity between the other items contained in the two baskets.

Usually, low lift and high similarity may indicate that two items are substitutes, meaning they are not likely to be bought together but the baskets in which they are found are similar. High lift means that the two items are likely to be bought together, not by chance, and thus may indicate that these are complementary items. While these procedures are widely used, they do not consider other retail characteristics that may further support the detected association or strengthen a disassociation. For example, when a 1.5 liter of some soda drink is out of stock, a 2 liter bottle of that soda drink may be desired by a shopper as a replacement. However, the traditional techniques described above fail to account for size.

The present systems and techniques solve these and other technological problems by using a model to detect associated item pairs.

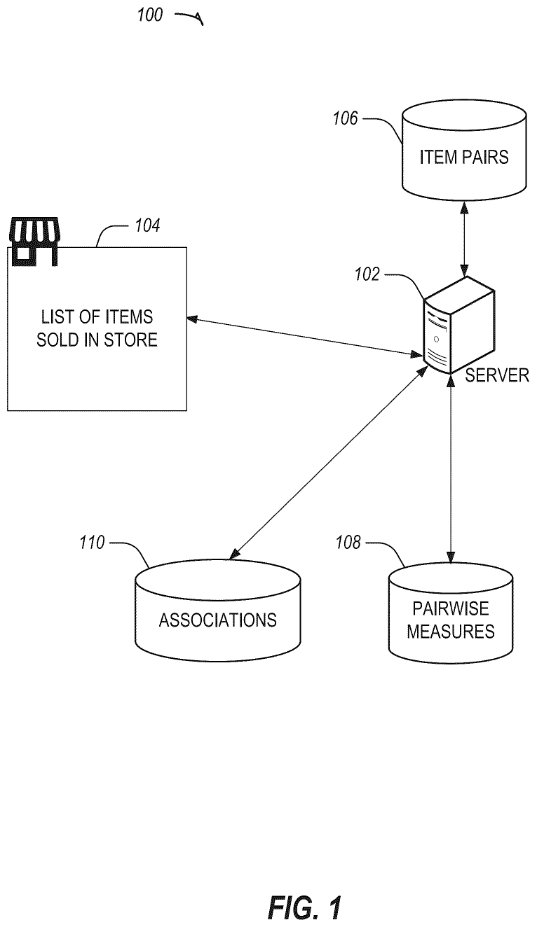

FIG. 1 illustrates a system 100 for determining anomalous item pairs using machine learning in accordance with some examples. The system 100 includes a server 102, which may perform the techniques described herein for identifying item associations. The server 102 receives input from a list of items sold in one or more stores 104. The server 102 may communicate with or include an item pairs database 106, which may store a dataset of all possible item pairs from the list of items sold in store 104. The server 102 may communicate with or include a pairwise measures database 108, which may store various pairwise measures extracted for each item pair. These measures may include item hierarchy values, frequency-related features, sales correlation values, item name similarity values, basket similarity values, price difference values, or quantity similarity measurement values. The server 102 uses these measures to evaluate the relationships between item pairs.

The server 102 may communicate with or include an association database 110, where the server 102 stores the results of the analysis, such as whether an anomalous pair was identified, whether a pair is a substitute or replacement, or the like. The server 102 uses an anomaly detection model to identify anomalous item pairs based on the pairwise measures, and the results may be stored in the association database 110.

The server 102 may obtain (e.g., construct, retrieve from one of the databases, receive from the store 104, or the like) a comprehensive dataset that includes all possible pairs of items within the retail inventory. For each pair of items, the server 102 extracts various pairwise measures from multiple data sources to quantify the relationship between the items.

The pairwise measures may include an item hierarchy measure, which identifies whether the two items belong to the same department or category within the retail structure. The pairwise measures may include frequency-related features, including how often each item is purchased individually, how frequently the items are bought together, and their lift. The server 102 may determine a correlation of sales between the two items across time, for example by analyzing the time series of pair sales and computing a correlation coefficient, resulting in a single numerical value representing the strength of their sales relationship over time. The server 102 may generate an item name similarity, for example using a language model trained on the relevant language (such as English) to understand context. For item name similarity, similarities between items like “apple” and “orange” due to their common context as fruits may be identified, independent of any specific retailer data. A language model (e.g., a large language model (LLM), a natural language processing (NLP) model, or the like) may be used to identify a similarity score (e.g., tomato sauce and ketchup have a score of 70 for relation, vs ketchup and garbage bags are 20). The score may be compared to a threshold to determine similarity.

The server 102 may use a machine learning model to calculate a basket-based similarity, identifying items with a similar or same context. For example, whisky and brandy may have a high basket similarity as they tend to appear in similar customer baskets. The server 102 may determine a price difference between items, relative to their department. In this example, expensive products may be identified to be more likely to be associated with other expensive products (e.g. an expensive wine is more likely to be associated with an expensive cheese than an inexpensive cheese). The pairwise measures may include quantity similarity measures, such as from an item name. Some item names contain information about the quantity in a unit, such as 1.5 L water or 6 pack 500 ml beer. These quantities may be used to deduce further association aspect. For example, a small bag of chips may be more associated with a 330 ml soda can than 1.5 L bottle of soda. A list of similar quantities can be identified by a language model, a conversion to some generic quantity, or by creating a manually defined list of pairwise sizes.

Some of the measures, such as name similarity may be calculated multiple times for different simplification levels of the items. As an example, consider two items with the following names: 1) “Organic banana” 2) “bananas 5 pack”. These two items represent the same fruit, so in aa “clean form” of both items an identifier may include simply “banana”. The name similarity may be calculated again: once for banana compared to banana (identical), and once for the original item names (still high similarity but not identical). The latter may capture similarities of other characteristics, such as some property of the items (e.g., “organic banana” and “organic apple”, similar sizes, etc.).

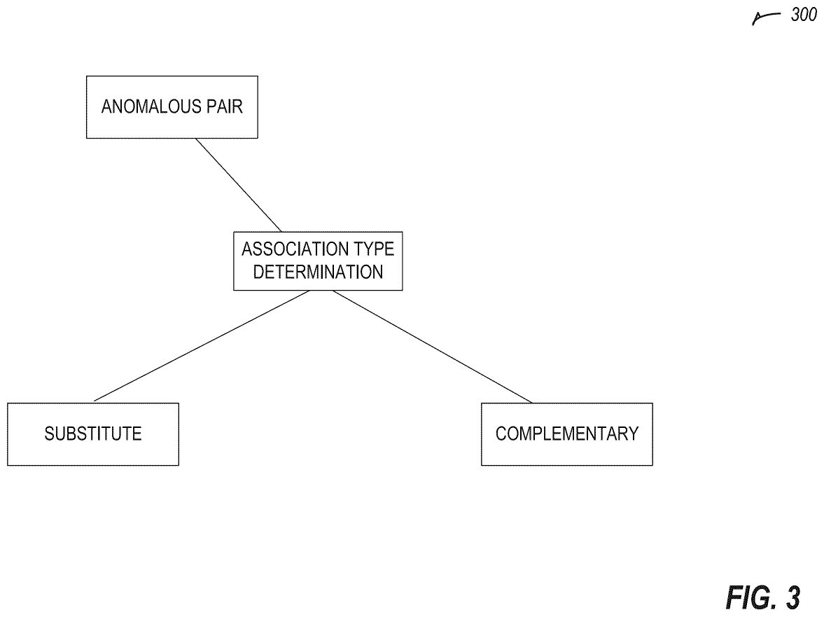

After identifying one or more anomalous pairs, (e.g., using an Isolation Forest model), items that belong to an anomalous pair may be classified as associated. Most pairs of items are not associated and thus associated items are rare and hold special characteristic, (e.g., they are represented as an abnormal combination of one or more of the measures above). An Isolation Forest model may be used to manage the large amount of data used for classifying, as well as managing noise in the data. In other examples, any anomaly detection model may be used. When classifying a pair as anomalous, the data is not labeled. After identifying one or more pairs the server 102 may determine whether the one or more pairs are substitutes or complimentary. Further discussion of substitutes or complimentary type is included below, associated with FIG. 3.

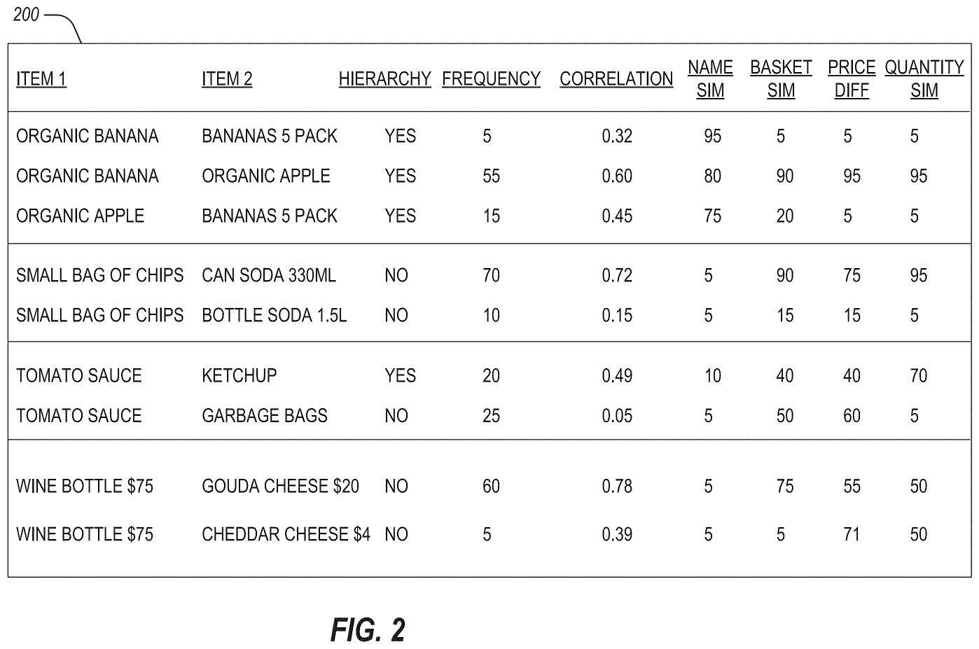

FIG. 2 illustrates generally a table 200 showing item pairs and pairwise measures in accordance with some examples. The table 200 includes example items that may be found in a store, such as a grocery store. The items in the table 200 are shown in pairs, although only a very limited number are shown for practical reasons. In practice, all item pairs, substantially all item pairs, a subset of item pairs, or the like may be added to the table 200 with pairwise measures.

Each row in the table 200 represents a pair of items, and the columns display various pairwise measures that quantify the relationship between the items. The first column of table 200 lists the first item in each pair, the second column lists the second item. The hierarchy column indicates whether the items belong to the same category or department within the retail structure. The frequency column provides a numerical value representing how often the items are purchased together. The correlation column indicates the correlation in sales between the two items over time. The name similarity column provides a score that reflects the similarity of the item names, for example based on an output of a language model to assess context. The basket similarity column measures how often the items appear together in customer baskets, indicating a shared context or usage. The price difference column shows the relative price difference between the items, which may influence analysis of their association. The quantity similarity column provides information about the quantity or size of the items, which can further define their relationship.

For example, the pair “Organic Banana” and “Bananas 5 Pack” shows a high name similarity score of 95, indicating a strong contextual similarity, while the frequency of purchase together is low at 5. The pair “Wine Bottle $75” and “Gouda Cheese $20” shows a high basket similarity score of 75, suggesting they are often purchased together, while the “Wine Bottle $75 has a much lower basket similarity score with “Cheddar Cheese $4.”

In an example, the pair “Organic Banana” and “Organic Apple,” has a name similarity score of 80 and a higher frequency of 55, with a positive correlation. The pair “Small Bag of Chips” and “Can Soda 330 ml” has a frequency of 70 and a positive correlation, despite a low name similarity score of 5. In contrast, “Tomato Sauce” and “Ketchup” share a name similarity score of 10 and a frequency of 20, but the correlation is low.

After table 200 is generated, the plurality of sets of pairwise measures may be used to determine one or more anomalous pairs using an anomaly detection model. For example, the anomaly detection model may use weightings, an average, a median, a relative difference, or the like to determine whether a pair is associated. Identified pairs may then be classified as substitutes or complementary, as described below.

FIG. 3 illustrates generally a block diagram 300 showing association type determination in accordance with some examples. The block diagram 300 begins with the classification of item pairs to determine whether they are associated. After association is established for one or more pairs, each pair where association is established may be evaluated to derive the nature of the association, which may be categorized as substitutes or complementary items.

The determination of association type may be achieved using one or more techniques. For example, a rule-based approach may include setting specific rules based on measures such as a threshold on the lift measure. These rules may be used to distinguish whether the items are substitutes or complementary. In some examples, the type determination may include using user feedback. User feedback may be used to refine the classification process, such as after applying rules, allowing for adjustments based on real-world insights and preferences. The type determination may include using unsupervised clustering. This approach may include using an unsupervised clustering model to group anomalies into meaningful categories based on their association type. This approach leverages that some associations may appear to be subjective or may not have a single definitive classification (e.g., some pairs may sometimes be substitutes, and sometimes replacements). For example, items like paprika and chili powder may be either substitutes or complementary, depending on the context.

In some examples, interpretability techniques may be applied to anomalous samples to further understand what measures contributed the most to the abnormality of the item pair. One such technique may include applying a Random Forest classifier on the training set. In this example, a label may be set to an indication of whether a particular pair is an anomaly or not.

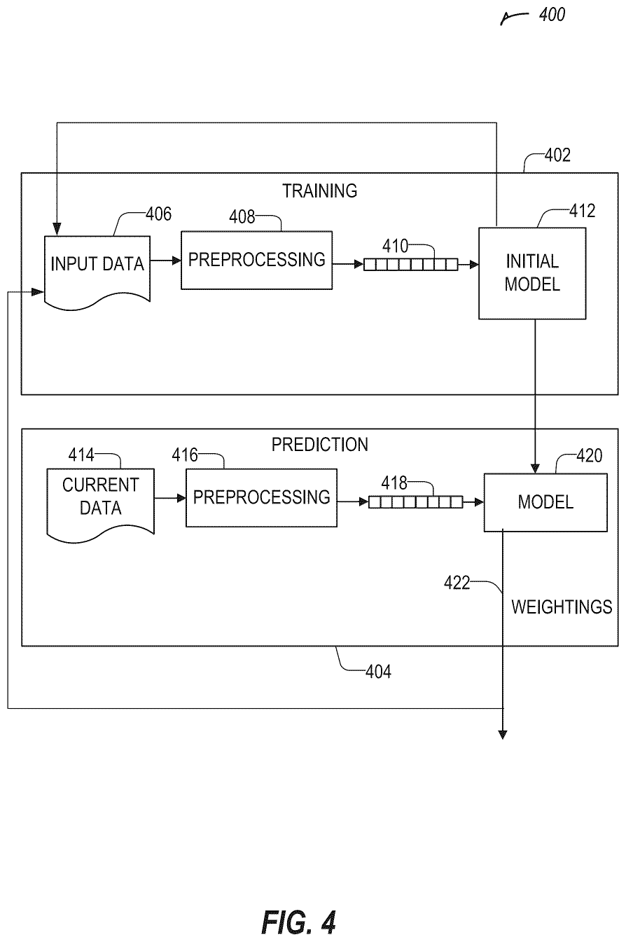

FIG. 4 illustrates a machine learning engine for training and execution related to determining anomalous item pairs, according to various examples.

The machine learning engine may be deployed to execute at a mobile device (e.g., a cell phone, a tablet, etc.) or a computer (e.g., a desktop, a laptop, etc.). FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412. An improved model may be redeployed for use.

The input data 406 may include a product item name, data corresponding to an item hierarchy value, a related frequency value, a sales correlation value, an item name similarity value, a basket similarity value, a price difference value, or a quantity similarity measurement value, or the like.

In the prediction engine 404, current data 414 (e.g., two items in a pair) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user.

Labels for the input data 406 may include whether a pair is anomalous, whether a pair (e.g., an anomalous pair) is a substitute or complementary, or the like.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

A language model may include a large language model (LLM), a natural language processing (NLP) model, or the like. Large Language Models (LLMs) are advanced artificial intelligence systems trained on vast amounts of text data to understand and generate human-like language. These models use deep learning techniques, particularly transformer architectures, to process and produce coherent and contextually relevant text across a wide range of topics and tasks. A NLP model is a model that analyzes and processes text data to translate, perform sentiment analysis, or generate text based on context.

Once trained, the model 420 may output a prediction, such as whether an item pair is anomalous, whether an item pair (e.g., an anomalous item pair) is a substitute or complementary pair, or the like.

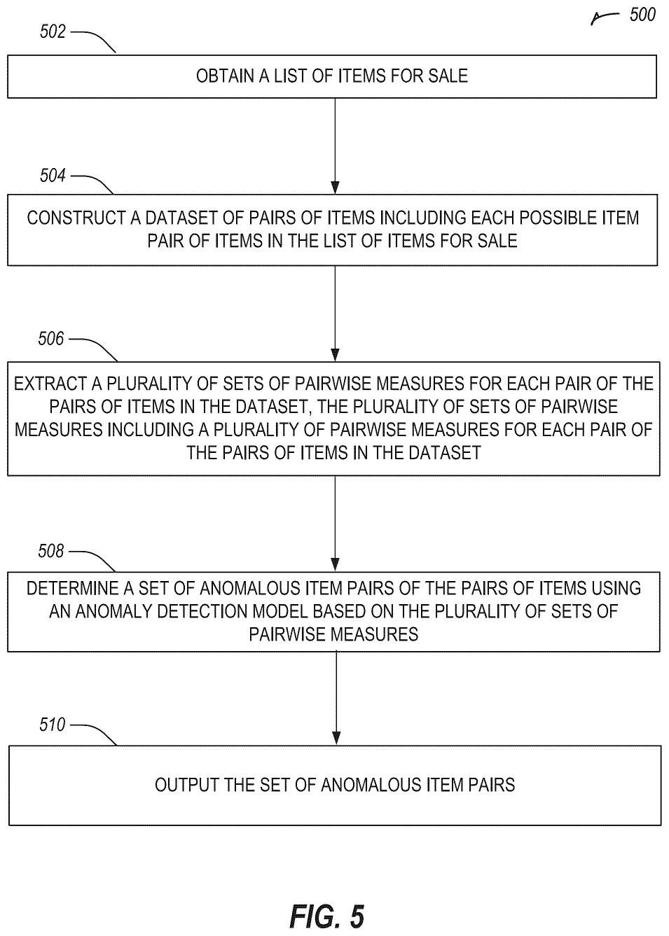

FIG. 5 illustrates generally a flowchart showing a technique 500 for determining anomalous item pairs using machine learning in accordance with some examples.

The technique 500 includes an operation 502 to obtain a list of items for sale. The technique 500 includes an operation 504 to construct a dataset of pairs of items including each possible item pair of items in the list of items for sale. The technique 500 includes an operation 506 to extract a plurality of sets of pairwise measures for each pair of the pairs of items in the dataset, the plurality of sets of pairwise measures including a plurality of pairwise measures for each pair of the pairs of items in the dataset.

The technique 500 includes an operation 508 to determine a set of anomalous item pairs of the pairs of items using an anomaly detection model based on the plurality of sets of pairwise measures. In an example, operation 506 includes generating a pairwise measure including at least one of an item hierarchy value, a related frequency value, a sales correlation value, an item name similarity value, a basket similarity value, a price difference value, or a quantity similarity measurement value. In this example, operation 508 may include using the anomaly detection model includes using a selected number of the values. In this example, operation 508 may include using the anomaly detection model includes identifying at least one anomalous value of the values. In this example, operation 506 may include generating the item name similarity value using a language model. The anomaly detection model may be an isolation forest model.

The technique 500 includes an operation 510 to output the set of anomalous item pairs. The technique 500 may include an operation to classifying each pair in the set of anomalous item pairs as being exclusively either an complementary pair type or a substitute pair type. This operation may include using a threshold lift value for each pair. This operation may include using an unsupervised clustering algorithm to cluster each pair into the complementary pair type or the substitute pair type.

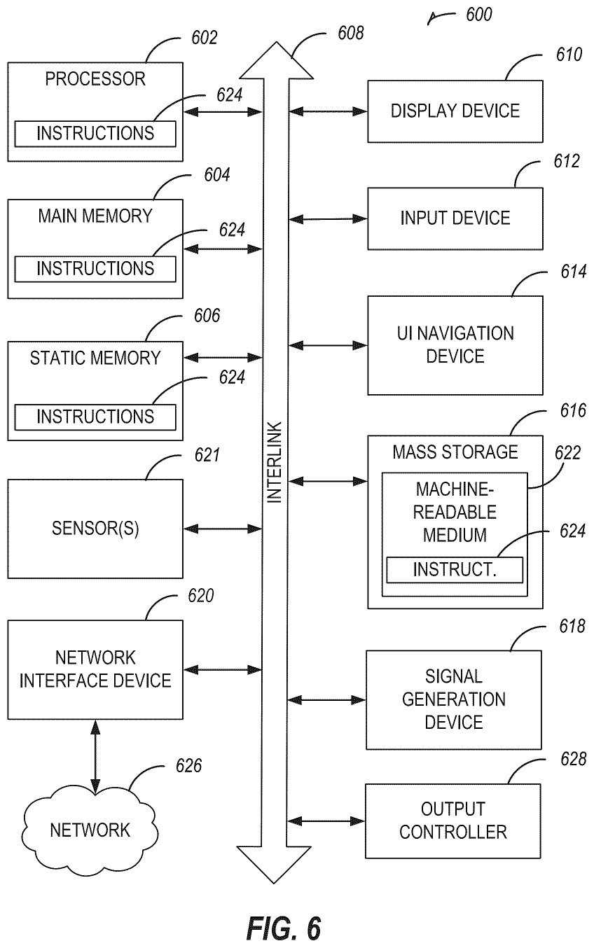

FIG. 6 illustrates generally an example of a block diagram of a machine 600 upon which any one or more of the techniques discussed herein may perform in accordance with some examples. In alternative examples, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

Each of these non-limiting examples may stand on its own, or may be combined in various permutations or combinations with one or more of the other examples.

Example 1 is a method comprising: obtaining a list of items for sale; constructing a dataset of pairs of items including each possible item pair of items in the list of items for sale; extracting a plurality of sets of pairwise measures for each pair of the pairs of items in the dataset, the plurality of sets of pairwise measures including a plurality of pairwise measures for each pair of the pairs of items in the dataset; determining a set of anomalous item pairs of the pairs of items using an anomaly detection model based on the plurality of sets of pairwise measures; and outputting the set of anomalous item pairs.

In Example 2, the subject matter of Example 1 includes, classifying each pair in the set of anomalous item pairs as being exclusively either an complementary pair type or a substitute pair type.

In Example 3, the subject matter of Example 2 includes, wherein classifying each pair in the set of anomalous item pairs includes using a threshold lift value for each pair.

In Example 4, the subject matter of Examples 2-3 includes, wherein classifying each pair in the set of anomalous item pairs includes using an unsupervised clustering algorithm to cluster each pair into the complementary pair type or the substitute pair type.

In Example 5, the subject matter of Examples 1-4 includes, wherein extracting the plurality of sets of pairwise measures includes generating a pairwise measure including at least one of an item hierarchy value, a related frequency value, a sales correlation value, an item name similarity value, a basket similarity value, a price difference value, or a quantity similarity measurement value.

In Example 6, the subject matter of Example 5 includes, wherein determining the set of anomalous item pairs of the pairs of items using the anomaly detection model includes using a selected number of the values.

In Example 7, the subject matter of Examples 5-6 includes, wherein determining the set of anomalous item pairs of the pairs of items using the anomaly detection model includes identifying at least one anomalous value of the values.

In Example 8, the subject matter of Examples 5-7 includes, wherein extracting the plurality of sets of pairwise measures includes generating the item name similarity value using a language model.

In Example 9, the subject matter of Examples 1-8 includes, wherein the anomaly detection model is an isolation forest model.

Example 10 is at least one non-transitory machine-readable medium including instructions, which when executed by processing circuitry, cause the processing circuitry to perform operations comprising: obtaining a list of items for sale; constructing a dataset of pairs of items including each possible item pair of items in the list of items for sale; extracting a plurality of sets of pairwise measures for each pair of the pairs of items in the dataset, the plurality of sets of pairwise measures including a plurality of pairwise measures for each pair of the pairs of items in the dataset; determining a set of anomalous item pairs of the pairs of items using an anomaly detection model based on the plurality of sets of pairwise measures; and outputting the set of anomalous item pairs.

In Example 11, the subject matter of Example 10 includes, classifying each pair in the set of anomalous item pairs as being exclusively either an complementary pair type or a substitute pair type.

In Example 12, the subject matter of Example 11 includes, wherein classifying each pair in the set of anomalous item pairs includes using a threshold lift value for each pair.

In Example 13, the subject matter of Examples 11-12 includes, wherein classifying each pair in the set of anomalous item pairs includes using an unsupervised clustering algorithm to cluster each pair into the complementary pair type or the substitute pair type.

In Example 14, the subject matter of Examples 10-13 includes, wherein extracting the plurality of sets of pairwise measures includes generating a pairwise measure including at least one of an item hierarchy value, a related frequency value, a sales correlation value, an item name similarity value, a basket similarity value, a price difference value, or a quantity similarity measurement value.

In Example 15, the subject matter of Example 14 includes, wherein determining the set of anomalous item pairs of the pairs of items using the anomaly detection model includes using a selected number of the values.

In Example 16, the subject matter of Examples 14-15 includes, wherein determining the set of anomalous item pairs of the pairs of items using the anomaly detection model includes identifying at least one anomalous value of the values.

In Example 17, the subject matter of Examples 14-16 includes, wherein extracting the plurality of sets of pairwise measures includes generating the item name similarity value using a language model.

In Example 18, the subject matter of Examples 10-17 includes, wherein the anomaly detection model is an isolation forest model.

Example 19 is a system comprising: processing circuitry; and memory, including instructions, which when executed by the processing circuitry, cause the processing circuitry to perform operations comprising: obtaining a list of items for sale; constructing a dataset of pairs of items including each possible item pair of items in the list of items for sale; extracting a plurality of sets of pairwise measures for each pair of the pairs of items in the dataset, the plurality of sets of pairwise measures including a plurality of pairwise measures for each pair of the pairs of items in the dataset; determining a set of anomalous item pairs of the pairs of items using an anomaly detection model based on the plurality of sets of pairwise measures; and outputting the set of anomalous item pairs.

In Example 20, the subject matter of Example 19 includes, classifying each pair in the set of anomalous item pairs as being exclusively either an complementary pair type or a substitute pair type.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
obtaining a list of items for sale;
constructing a dataset of pairs of items including each possible item pair of items in the list of items for sale;
extracting a plurality of sets of pairwise measures for each pair of the pairs of items in the dataset, the plurality of sets of pairwise measures including a plurality of pairwise measures for each pair of the pairs of items in the dataset;
determining a set of anomalous item pairs of the pairs of items using an anomaly detection model based on the plurality of sets of pairwise measures; and
outputting the set of anomalous item pairs.

2. The method of claim 1, further comprising classifying each pair in the set of anomalous item pairs as being exclusively either an complementary pair type or a substitute pair type.

3. The method of claim 2, wherein classifying each pair in the set of anomalous item pairs includes using a threshold lift value for each pair.

4. The method of claim 2, wherein classifying each pair in the set of anomalous item pairs includes using an unsupervised clustering algorithm to cluster each pair into the complementary pair type or the substitute pair type.

5. The method of claim 1, wherein extracting the plurality of sets of pairwise measures includes generating a pairwise measure including at least one of an item hierarchy value, a related frequency value, a sales correlation value, an item name similarity value, a basket similarity value, a price difference value, or a quantity similarity measurement value.

6. The method of claim 5, wherein determining the set of anomalous item pairs of the pairs of items using the anomaly detection model includes using a selected number of the values.

7. The method of claim 5, wherein determining the set of anomalous item pairs of the pairs of items using the anomaly detection model includes identifying at least one anomalous value of the values.

8. The method of claim 5, wherein extracting the plurality of sets of pairwise measures includes generating the item name similarity value using a language model.

9. The method of claim 1, wherein the anomaly detection model is an isolation forest model.

10. At least one non-transitory machine-readable medium including instructions, which when executed by processing circuitry, cause the processing circuitry to perform operations comprising:
obtaining a list of items for sale;
constructing a dataset of pairs of items including each possible item pair of items in the list of items for sale;
extracting a plurality of sets of pairwise measures for each pair of the pairs of items in the dataset, the plurality of sets of pairwise measures including a plurality of pairwise measures for each pair of the pairs of items in the dataset;
determining a set of anomalous item pairs of the pairs of items using an anomaly detection model based on the plurality of sets of pairwise measures; and
outputting the set of anomalous item pairs.

11. The at least one non-transitory machine-readable medium of claim 10, further comprising classifying each pair in the set of anomalous item pairs as being exclusively either an complementary pair type or a substitute pair type.

12. The at least one non-transitory machine-readable medium of claim 11, wherein classifying each pair in the set of anomalous item pairs includes using a threshold lift value for each pair.

13. The at least one non-transitory machine-readable medium of claim 11, wherein classifying each pair in the set of anomalous item pairs includes using an unsupervised clustering algorithm to cluster each pair into the complementary pair type or the substitute pair type.

14. The at least one non-transitory machine-readable medium of claim 10, wherein extracting the plurality of sets of pairwise measures includes generating a pairwise measure including at least one of an item hierarchy value, a related frequency value, a sales correlation value, an item name similarity value, a basket similarity value, a price difference value, or a quantity similarity measurement value.

15. The at least one non-transitory machine-readable medium of claim 14, wherein determining the set of anomalous item pairs of the pairs of items using the anomaly detection model includes using a selected number of the values.

16. The at least one non-transitory machine-readable medium of claim 14, wherein determining the set of anomalous item pairs of the pairs of items using the anomaly detection model includes identifying at least one anomalous value of the values.

17. The at least one non-transitory machine-readable medium of claim 14, wherein extracting the plurality of sets of pairwise measures includes generating the item name similarity value using a language model.

18. The at least one non-transitory machine-readable medium of claim 10, wherein the anomaly detection model is an isolation forest model.

19. A system comprising:
processing circuitry; and
memory, including instructions, which when executed by the processing circuitry, cause the processing circuitry to perform operations comprising:
obtaining a list of items for sale;
constructing a dataset of pairs of items including each possible item pair of items in the list of items for sale;
extracting a plurality of sets of pairwise measures for each pair of the pairs of items in the dataset, the plurality of sets of pairwise measures including a plurality of pairwise measures for each pair of the pairs of items in the dataset;
determining a set of anomalous item pairs of the pairs of items using an anomaly detection model based on the plurality of sets of pairwise measures; and
outputting the set of anomalous item pairs.

20. The system of claim 19, further comprising classifying each pair in the set of anomalous item pairs as being exclusively either an complementary pair type or a substitute pair type.
